(19) United States
(12) Patent Application Publication
(10) Pub. No.: US 2016/0255966 A1
(43) Pub. Date: Sep. 8, 2016

(54) REAL TIME ADAPTABLE BODY SUPPORT SYSTEM AND METHOD OF OPERATION

(71) Applicant: Sealy Technology, LLC, Trinity, NC (US)

(72) Inventor: Darin T. Thomas, Salisbury, NC (US)

(73) Assignee: Sealy Technology, LLC, Trininty, NC (US)

(21) Appl. No.: 14/636,370

(22) Filed: Mar. 3, 2015

(51) Int. Cl. A47C 27/08; A47C 27/18; G05B 15/02; A47C 27/10

(52) U.S. Cl. CPC A47C 27/083; A47C 27/082; A47C 27/10; A47C 27/18; G05B 15/02

(57) ABSTRACT

A system for adjusting a body support during use includes a body support having an adjustable layer and a plurality of sensors, and a processing system in communication with the plurality of sensors and the adjustable layer. The processing system receives information from the plurality of sensors and then transmits instructions to the adjustable layer to adjust the layer. One or more cameras can also be used to gather data for receipt by the processing system in order to determine whether and how to adjust the layer.

### FIELD OF THE INVENTION

The present invention relates to a body support systems. More specifically, the present invention relates to body support systems that adapt to a user to maximize support and relative comfort of the user.

### BACKGROUND

Body supports are generally known in the art, and often include one or more deformable elements provided to support one or more body parts of a human or animal. A body support may include, but is not limited to, a mattress, pillow, or cushion, including those for use in beds, seats, or chairs. A body support may be any desired shape or size suitable to support a portion, up to and including the entirety, of the user.

Known body supports may be constructed of a single layer of material. For example, a body support may be constructed of a single layer of natural material, such as cotton, down, and other natural materials, foam and other synthetic materials, devices and objects such as air bladders, metal or plastic springs, and the like. Still other body supports may be constructed of multiple layers of any of these materials. For example, multi-layer body supports can be made of two or more layers of synthetic foams, such as polyurethane viscoelastic or non-viscoelastic foam, latex foam, and/or other foam materials.

Known single and multi-layer body supports are generally mass produced. During mass production, each layer of the body support is typically constructed of a homogeneous material based on a uniform pattern or design. Accordingly, each layer is typically constructed to have the same dimensions and physical properties across the body support.

Known body supports are also not generally customized to the body type of a user. Commercially available body supports are typically sold by a level of firmness, for example firm, plush, euro plush, and pillow top. Some other known body supports provide firmness adjustment, for example by providing internal air chambers that may be inflated or deflated with air to respectfully increase or decrease the firmness. While these known body supports allow a user to select or adjust firmness, these body supports are generally not manufactured so that they are customized to the user. Instead, such adjustable body supports typically require the user to adjust the body support to the user's preferences. This often limits the degree to which the body support can be adjusted to the user. Also, such body supports often have limited firmness customization across the body support, and are often not customized to the body type of the user.

### SUMMARY OF THE INVENTION

The invention provides, in one aspect, a system for adjusting a body support during use, including a body support having an adjustable layer and a plurality of sensors, and a processing system in communication with the plurality of sensors and the adjustable layer. The processing system receives information from the plurality of sensors and then transmits instructions to the adjustable layer to adjust the layer.

The invention provides, in another aspect, a system for adjusting a body support during use, including a body support having an adjustable layer, a body image scanner in operational communication with the body support, and a processing system in communication with the adjustable layer by a first communication link, and in communication with the body image scanner by a second communication link. The processing system receives depth image information from the body image scanner and then transmits instructions to the adjustable layer to adjust the layer.

Other features and aspects of the invention will become apparent by consideration of the following detailed description and accompanying drawings.

### BRIEF DESCRIPTION OF THE DRAWINGS

FIG. 1 is an schematic view of an adaptable body support system in accordance with an embodiment of the invention.

FIG. 2 is a partial cross-section of an embodiment of a portion of a body support for use with the adaptable body support system of FIG. 1.

FIG. 3 is a schematic diagram of an embodiment of an adjustable bladder for use in the adjustable layer of the body support of FIG. 2, showing the adjustable bladder in an inflated or first position.

FIG. 4 is a schematic diagram of an embodiment of an adjustable bladder for use in the adjustable layer of the body support of FIG. 2, showing the adjustable bladder in a deflated or second position.

FIG. 5 is an isometric view of an embodiment of a portion of a body support layer for use in the body support of FIG. 2, showing the layer being manufactured with a cell-to-cell additive manufacturing process.

FIG. 6 is a schematic diagram of a processing system used with the adaptable body support system of FIG. 1.

FIG. 7 is flow diagram of an operation application for use with the adaptable body support system of FIG. 1, wherein the application captures and analyzes information to responsively adjust the body support to changing conditions.

FIG. 8 is a plan view of sleeping positions, including the fetus, log, yearner, freefaller, and starfish positions, employed by the user of the adaptable body support system of FIG. 1

Before embodiments of the present invention are explained in detail, it should be understood that the invention is not limited in its application to the details or construction and the arrangement of components as set forth in the following description or as illustrated in the drawings. The invention is capable of other embodiments and of being practiced or of being carried out in various ways. It should be understood that the description of specific embodiments is not intended to limit the disclosure from covering all modifications, equivalents, and alternatives falling within the spirit and scope of the disclosure. Also, it is to be understood that the phraseology and terminology used herein is for the purpose of description, and should not be regarded as limiting.

### DETAILED DESCRIPTION

Embodiments of the present invention illustrated in the Figures and disclosed herein are generally directed to an adaptable body support system 100 that monitors the user 200 during use, and adapts a body support 110 to the user 200 to improve the relative comfort of the user 200. By monitoring the user 200 during use, the body support system 100 generates information about the user 200 and the body support 110. As the user 200 moves during use, conditions associated with relative comfort of the user 200 change. The body support system 100 utilizes the information to responsively adjust the body support 110 to the change in conditions. This adaptability, which is some embodiments can be real-time, improves user support and the relative comfort of the user 200, which in turn improves the experience and sleep quality for the user 200.

For ease of discussion and understanding, the following detailed description refers to a body support 110, and illustrates the body support 110 as a mattress. It should be appreciated that the mattress is provided for purposes of illustration only. The features described herein in association with the body support 110 are applicable to any suitable element provided to support one or more body parts of a human or animal. Accordingly, the term body support may include, but is not limited to, a mattress, mattress topper, overlay, futon, sleeper sofa, cushion, seat cushion, seat back, pillow, neck pillow, leg spacer pillow, eye mask, or any other element provided to support a portion, up to and including the entirety, of a human or animal. In addition, the body support 110 may be any suitable or desired size or shape.

It should also be appreciated that the term “relative comfort” of the user 200 refers to how comfortable or physically content the user 200 is in association with the body support 110 at any given moment in time. The term relative comfort may generally be a subjective level of physical comfort felt by the user 200 at a given moment while using the body support 110, or after the conclusion of use of the body support 110. Relative comfort may also change from moment to moment, and may be unique to one or more different users 200.

In addition, it should be appreciated that the terms “physical property” and “physical properties” of the body support 110 are inclusive of properties of the body support 110 that may be modified, controlled, or adjusted during manufacturing. Physical properties of the body support 110 include, but are not limited to, firmness, density, sag-factor, air flow, resilience, hardness of material, and compression.

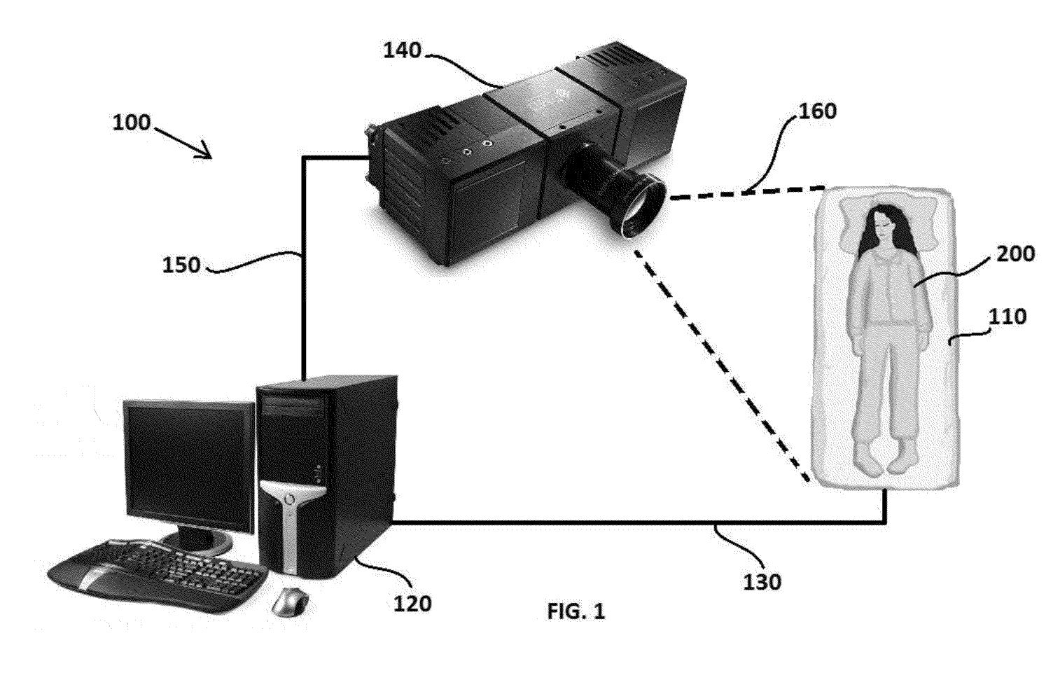

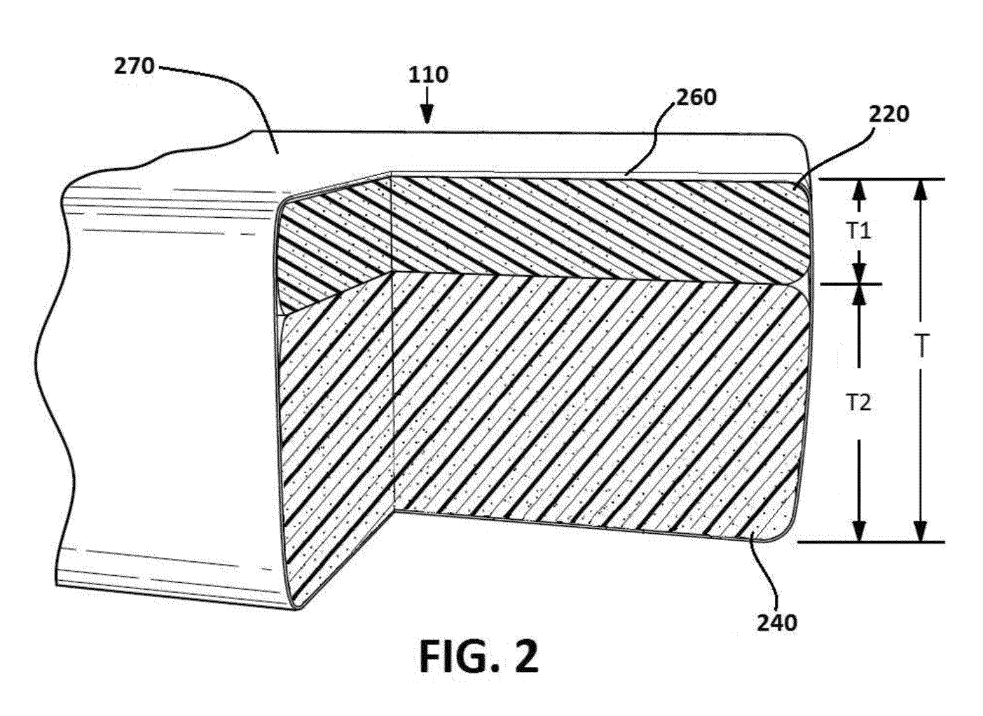

Referring now to the figures, FIG. 1 illustrates an embodiment of the adaptable body support system 100. The support system 100 includes a body support 110 in communication with a processing system 120 through a first communication link 130. The body support 110 provides support for the user 200, and includes a plurality of sensors 260 (shown in FIG. 2) that generate information associated with the user 200 using the body support 110 at a given moment in time. The sensors 260 transmit the information to the processing system 120 through the first communication link 130. The system 100 also includes a body image scanner 140 in communication with the processing system 120 through a second communication link 150. The body image scanner 140 includes one or more cameras, and is in operational communication with the body support 110. Stated otherwise, the body image scanner 140 scans and captures one or more digital images 160 of the user 200 using the body support 110, and transmits the digital images 160 to the processing system 120 through the second communication link 150. The processing system 120 utilizes the information from sensors 260 and the digital images 160 to generate and provide adaptive adjustment instructions to the body support 110. The processing system 120 transmits the adaptive adjustment instructions to the body support 110 through the first communication link 130. Based on the adaptive adjustment instructions, the body support 110 adjusts to provide improved support to the user 200.

Referring now to FIG. 2, the body support 110 includes a plurality of layers 220, 240. A first layer or adjustable layer 220 adjoins or is stacked on a second layer 240. The first layer 220 defines a first thickness T1, while the second layer 240 defines a second thickness T2. The layers 220, 240 cooperatively define a total thickness T of the body support 110. While the first thickness T1 is illustrated as less than the second thickness T2, in other embodiments the first thickness T1 may be equal to or greater than the second thickness T2. In addition, in other embodiments, the body support 110 may include a single adjustable layer, or three or more total layers. In embodiments with three or more total layers, the body support 110 may include a plurality of adjustable layers 220. Further, in other embodiments one or more layers may be stacked on the adjustable layer 220. One or more of the layers 220, 240 may also have a profiled top and/or bottom surface, such as a plurality of projections and convolutions (not shown). The profiled surface(s) may be provided in any of the plurality of layers to attain a desired physical property of the body support 110 or relative comfort of the user 200.

In the illustrated embodiment, the plurality of sensors 260 are arranged in an array, hereinafter referred to as a sensor array 260. The sensor array 260 is positioned on the adjustable layer 220. The sensor array 260 can measure the location and/or magnitude of pressure and/or force applied on the body support 110. In addition, the sensor array 260 can measure peak pressures and/or overall pressure distribution patterns. An example of a suitable sensor array 260 is the BODY PRESSURE MEASUREMENT SYSTEM or BPMS (available from TEKSCAN, INC. headquartered in South Boston, Mass.). The sensor array 260 is in communication with the processing system 120, for example through the first communication link 130. In other embodiments, the sensor array 260 may be positioned between the first (or adjustable) layer 220 and second layer 240, or at any other suitable or desired position in the body support 110.

An outer barrier 270 encases a portion, or the entirety, of the plurality of layers 220, 240 and sensor array 260 of the body support 110. The outer barrier 270 may be a fire barrier, a ticking, or other suitable or desired material.

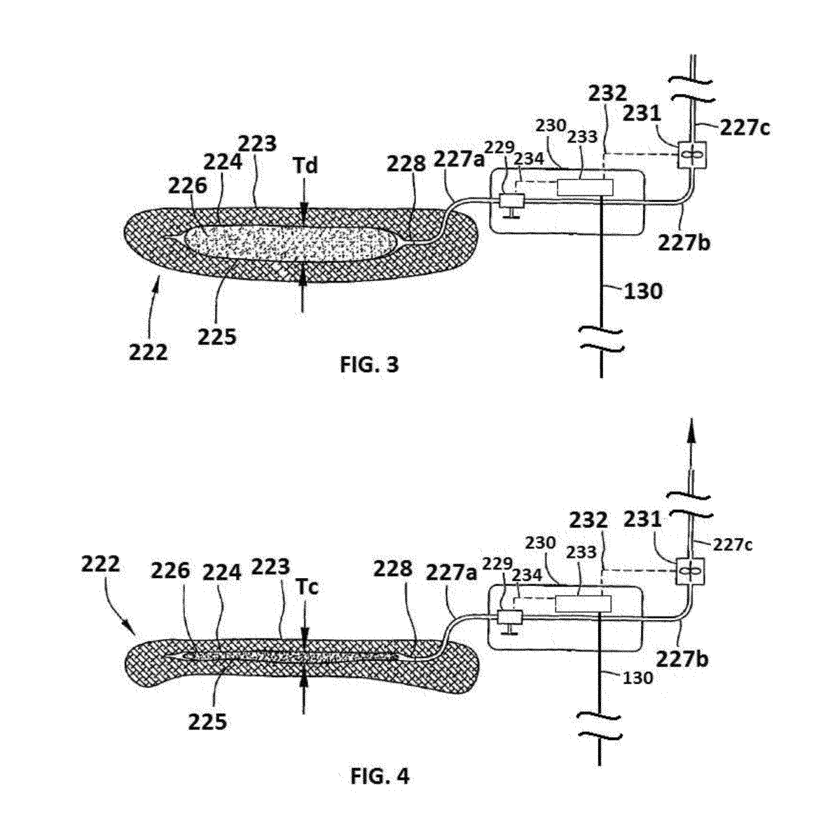

With reference to the illustrated embodiment, the adjustable layer or first layer 220 includes a plurality of adjustable bladders 222. Referring now to FIG. 3, one of the adjustable bladders 222 is illustrated. The adjustable bladder 222 is a vacuum bladder 222 defined by a cushion or pad 223 with an internal cavity 224. A bladder 225 is positioned in the cavity 224 and filled with foam 226. However, in other embodiments, the bladder 225 may be filled only with air or another suitable fluid. The bladder 225 is illustrated in a first or inflated position, with the bladder 225 having a first, inflated or default thickness Td. The pad 223 may be formed of foam or any other suitable or desired material. The foam of pad 223 and the foam 226 may have the same formulation or different formulations. In other embodiments, the adjustable bladders 222 may include only air bladders or any other suitable adjustable or inflatable device, without the pad 223.

The bladder 225 is fluidly connected to a tube 227a by an inlet 228. The tube 227a exits the pad 223 to a control unit 230. The control unit 230 includes one or more valves or solenoid valves 229 associated with one or more adjustable bladders 222. The valves 229 are in electrical communication with a controller 233 through a first control line 234. A vacuum pump 231 is in fluid communication with the control unit 230 by tube 227b, and is in electrical communication with the controller 233 by a second control line 232. The vacuum pump 231 also includes a discharge tube 227c. The controller 233 is in communication with processing system 120 (shown in FIG. 1) by the first communication link 130. The controller 233 includes electronics that provide a signal through the first control line 234 to one or more of the valves 229 to selectively open and close, and a signal through the second control line 232 to the vacuum pump 231 to operate in a forward or reverse direction, based on the instructions received from the processing system 120. In various embodiments, a manifold or other distribution device may be in fluid communication with the one or more valves 229 to facilitate fluid flow to one or more adjustable bladders 222.

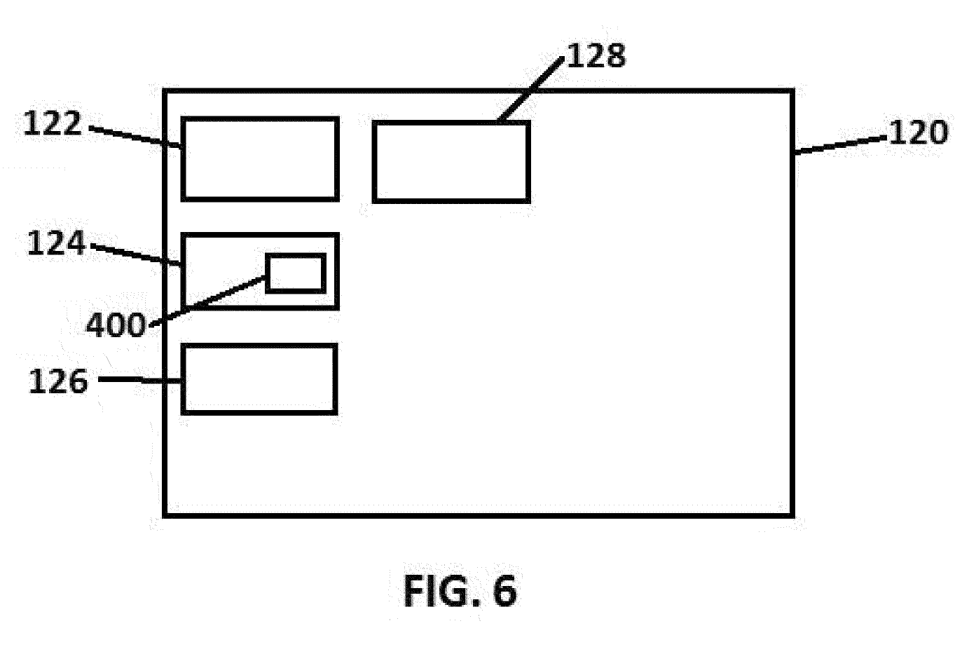

Referring to FIG. 4, the bladder 225 is illustrated in a second or collapsed position, with the bladder 225 having a second, deflated or compressed thickness Tc. By operation of the vacuum pump 231, air is drawn out of the bladder 225 through the tube 227a, b, c, shown in FIG. 6 as the arrow exiting tube 227c. As air is drawn out, the bladder 225 deflates or compresses, and in turn the pad 223 compresses. It should be appreciated that while the bladder 225 is illustrated in FIGS. 3 and 4 as having a first, default thickness Td and a second, compressed thickness Tc, the thickness of the bladder 225 may be adjusted to be at or between the first and second thicknesses Td, Tc.

While FIGS. 3 and 4 illustrate an adjustable bladder 222, in various embodiments, a plurality of adjustable bladders 222 are connected to the control unit 230. Thus, the valve 229 for each bladder 222 may be opened or closed by the controller 233 separately in order to adjust one or more desired bladders 222 provided in the adjustable layer 220.

Referring back to FIG. 2, the second layer 240 of the illustrated embodiment is formed of a homogeneous material within the layer, and is preferably foam. However, in other embodiments, the second layer 240 may be formed of two or more different foam formulations, different layers of foam, or other heterogeneous materials. In addition, the second layer 240 may include additives, such as phase change material, or be formed of materials other than foam or in addition to foam, such as fibers, springs, fabrics, or other suitable or desired materials, by way of example only.

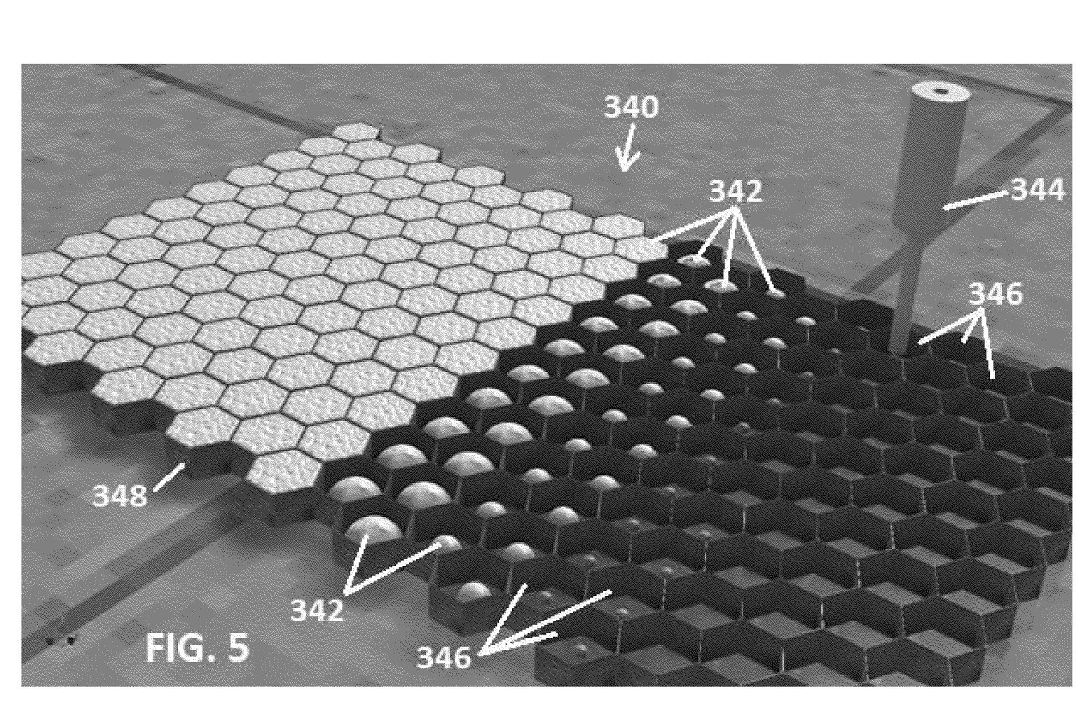

FIG. 5 illustrates an alternative embodiment of the second layer 340, wherein the layer 340 is manufactured through a cell-to-cell additive manufacturing process. The layer material 342, illustrated as expanding foam, is dispensed by a distribution head 344 into a plurality of interconnected cells 346 defined by a cellular frame structure 348. One or more pressure or force sensors (not shown), such as those used in sensor array 260, may be prepositioned in one or more of the cells 346, or inserted in one or more of the cells 346 during or shortly after the layer material 342 is dispensed. In other embodiments, the sensor array 260 may be positioned on the second layer 340 after the layer material 342 is dispensed.

The cellular frame structure 348 may be formed of a nonwoven material, or any other suitable or desired material. While the cells 346 are illustrated as having a polygonal shape, and specifically a hexagon, in other embodiments the cells 346 may be any suitable shape or combination of shapes. After the layer material 342 fills each of the cells 346, the frame structure 348 may remain, may be physically removed, or may dissolve. In embodiments where the frame structure 348 remains, it is preferable that the frame structure 348 is not rigid, or has sufficient flexibility so as to not negatively influence the relative comfort of the user during use of the body support 110.

The foam used to in the adjustable layer 220 and second layer 240 may include, but is not limited to, viscoelastic foam, non-viscoelastic foam, latex foam, polyurethane foam, and/or any known or future developed suitable expanded polymer, such as expanded ethylene vinyl acetate, polypropylene, polystyrene, or polyethylene. In addition, the foam may be reticulated foam or non-reticulated foam. Reticulated foam is a cellular foam structure in which the cells of the foam are essentially skeletal. In other words, the cells of the reticulated foam are each defined by a plurality of apertured windows surrounded by cell struts. The cell windows of reticulated foam can be entirely gone (leaving only the cell struts) or substantially gone. Foam may be considered “reticulated” if a portion of the windows of the cells are missing (i.e., windows having apertures therethrough, or windows that are completely missing and therefore leaving only the cell struts). As a non-limiting example, foam may be considered “reticulated” if at least 50% of the windows of the cells are missing. Such structures can be created by destruction or other removal of cell window material, or by preventing the complete formation of cell windows during the manufacturing process of the foam. Non-reticulated foam includes a cellular structure, wherein the walls of the individual cells are substantially intact. Also, phase change material may be injected, embedded, infused, or otherwise included with the one or more types of foam. The phase change material may be encapsulated phase change material or unencapsulated phase change material. Phase change material generally provides latent heat storage through a change in phase of the material (such as a solid-liquid phase change material).

Referring back to FIG. 1, the body image scanner 140 is one or more cameras positioned to observe the user 200 during use of the body support 110. The cameras capture digital images 160 of the user 200. An example of a suitable body image scanner 140 is one or more time-of-flight (TOF) cameras 140. The time-of-flight camera 140 emits intermittent light pulses to illuminate a target. Preferably, the emitted light is outside the visible light spectrum of 390 to 700 nanometers. Stated otherwise, the emitted light is less than 390 nanometers or greater than 700 nanometers. By emitting light outside the visible light spectrum, the time-of-flight camera 140 does not disturb a user 200 during use of the body support 110 (i.e. allows the user 200 to sleep). The camera 140 measures the time-of-flight of the emitted light, based on the known speed of light, between the camera 140 and the subject 200 for each point of an image 160. The measurements are analyzed to develop a digital distance or depth or range image 160 in real time. The time-of-flight camera 140 captures an entire scene in the digital image 160 with each light pulse, providing very fast image capture and range image generation. This real time range image capture enables movement tracking of the user 200. While the body image scanner 140 is illustrated as a time-of-flight camera 140, in other embodiments, the body image scanner 140 may be any suitable known or future developed device for capturing motion images of the user 200.

The body image scanner 140 is electrically connected to the processing system 120 through the second communication link 150. Similarly, the body support 110 is electrically connected to the processing system 120 through the first communication link 130. The communication links 130, 150 each provide a pathway for communication between the processing system 150 and the respective body support 110 and body image scanner 140. The communication links 130, 150 are illustrated as a Category 5 or Cat5 cable. However, in other embodiments, the communication links 130, 150 may be any suitable communications protocol or pathway, including, but not limited to, wireless communication, transmission control protocol/internet protocol (TCP/IP), Ethernet, or universal serial bus (USB).

The processing system 120 is a programmable computer system in communication with the body support 110 and the body image scanner 140. Referring now to FIG. 6, the processing system 120 includes random access memory (RAM) 122, a computer readable storage medium or hard drive 124, a processor 126, and a port (e.g., an Ethernet port 128, by way of example only) for connecting the processing system 120 to a distributed network, such as the Internet. The processing system 120 may include executable instructions or a computer readable code to receive and store information about the user 200 and the body support 110 from the sensor array 260, such as location and/or magnitude data of pressure and/or force applied by the user 200 to the body support 110, peak pressures and/or overall pressure distribution patterns, and images and/or video of the user 200 acquired by the body image scanner 140. The executable instructions may further include instructions to construct a pressure and/or force map of the body support 110, to generate a digital likeness of the user 200, and to store the digital likeness. In addition, the executable instructions may include analysis steps that analyze the information from the sensor array 260 and/or the digital images or digital likenesses of the user, and associated commands to adjust aspects of the body support 110 to improve support and relative comfort of the user 200 in response to changing conditions identified in the analysis steps.

In one or more examples of embodiments, the processing system 120 may be any known or future developed programmable computer processor system suitable for communication with the body support 110 and/or body image scanner 140, and to process and analyze any and all data as disclosed herein. The processing system 120 may also have a user interface of manual or specific body support 110 adjustments depending upon conditions desired by the user 200. In other examples of embodiments, the computer readable storage medium 124 may include any data storage device which can store data that can be thereafter read by a computer system. Examples of computer readable storage medium 124 may include read-only memory, CD-ROM, CD-R, CD-RW, DVD, DVD-RW, magnetic tapes, Universal Serial Bus (USB) flash drive, or any other magnetic, optical or other suitable data storage device. The computer readable storage medium 124 may also be distributed over a network coupled to or in communication with the processing system 120 so that any executable instructions are stored and/or executed in a distributed fashion.

While the adaptable body support system 100 discloses both the body support 110 having the sensor array 260 that generates information about the user 200 and the body support 110, and the body image scanner 140 that generates digital range image data to track the movement of the user 200 while using the body support 110, in other embodiments the support system 100 may incorporate one of the body support 110 having the sensor array 260, or alternatively the body image scanner 140.

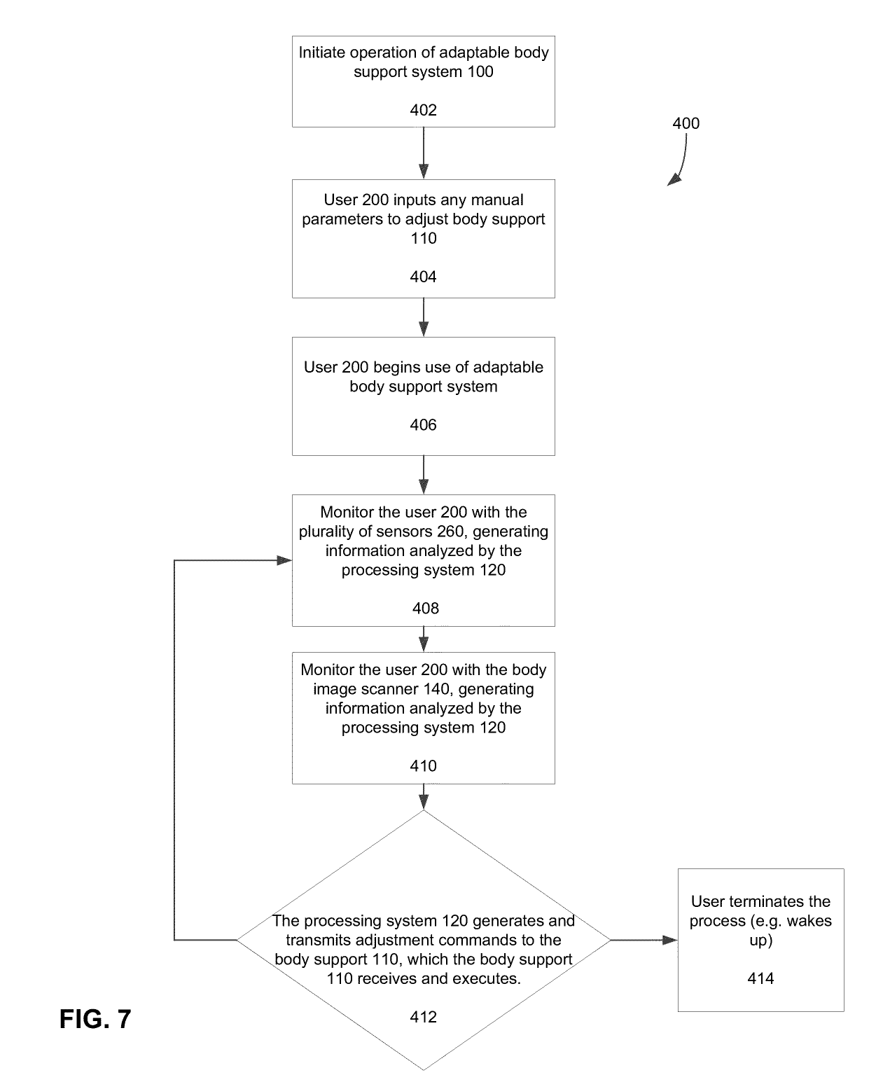

FIG. 7 illustrates an example of an operations application 400 for use with the adaptable body support system 100. The application or module 400 includes a series of processing instructions or steps that are depicted in flow diagram form. The application 400 may be distributed, stored, and executed on the computer readable storage medium 124 of the processing system 120 (as shown in FIG. 6), or is accessible for execution from a remote location, such as through a web portal, web site, or generally over the Internet.

Referring to FIG. 7, the application or process 400 begins at step 402, where a user 200 initiates operation of the adaptable body support system 100 and prepares to use the body support 110. The processing system 120 and body image scanner 140 are powered on, and the body image scanner 140 and plurality of sensors 260 have active lines of communication with the processing system 120.

Next, at step 404, the user 200 may input any manual parameters to provide specific adjustments to the body support 110. Such manual parameters may include, but are not limited to, providing instructions to adjust one of more of the adjustable bladders 222 of the adjustable layer 220 of the body support 110. Such a manual adjustment may be desired to provide an initial level of support or relative comfort desired by the user 200.

At step 406, the user 200 begins use of the adaptable body support system 100. More specifically, the user 200 begins use of the body support 110. For example, as illustrated in FIG. 1, the user 200 lays down and falls asleep on the body support 110. For reference, the user 200 is illustrated in the “soldier” sleeping position.

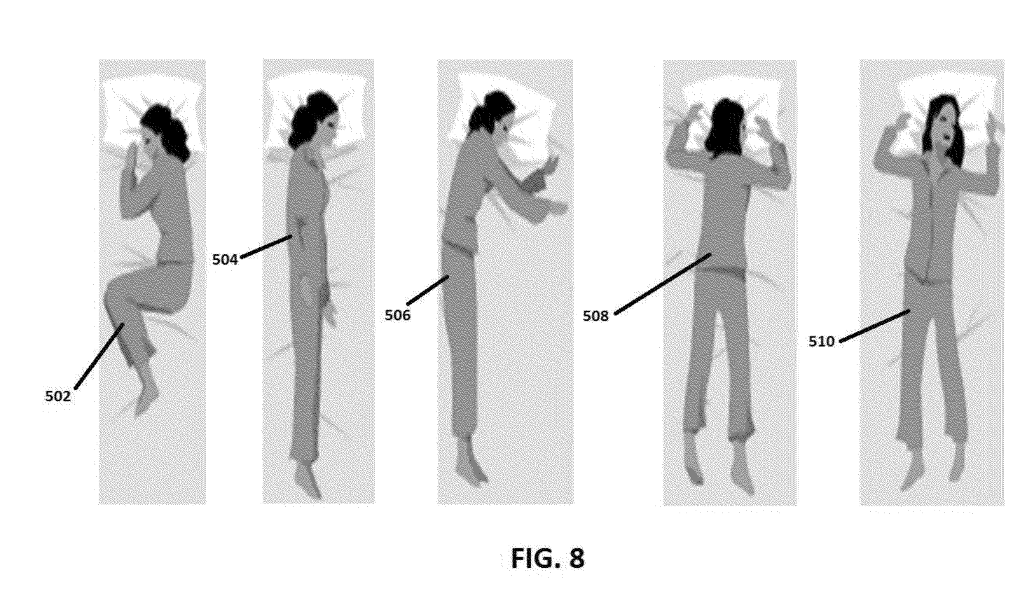

Next, at step 408, while the user 200 is asleep, the plurality of sensors 260 monitor the user 200 using the body support 110 and generate information regarding the user in real time. For example, and with reference to the illustrated embodiment, the sensors 260 measure the location and magnitude of both pressure and force applied by the user 200 on the body support 110, and peak pressures and overall pressure distribution patterns across the body support 110. The generated information is transmitted through the first communication link 130 to the processing system 120, where the information is analyzed. During the analysis, changes in the generated information are indicative of changes in the body support 110 conditions, and thus the user support and relative comfort of the user 200. If the analysis determines the change is adversely affecting user support and/or relative comfort of the user 200, such as an increase in pressure over a particular threshold at a location on the body support 110, the analysis will provide commands to the body support 110 to adapt to the changing conditions. For example, the changing conditions may be caused by movement of the user 200 while sleeping. The user 200 may move into a different sleep position, such as moving from the “soldier” position in FIG. 1 to another sleeping position, such as any of those illustrated in FIG. 8, including a fetus 502, a log 504, a yearner 506, a freefaller 508, and/or a starfish 510 position.

Simultaneously, or sequentially, at step 410, the body image scanner 140 scans and captures one or more digital depth images 160 of the user 200. The body image scanner 140 transmits the digital depth images 160 through the second communications link 150 to the processing system 120, where the digital depth images 160 are analyzed. During the analysis, changes in the depth images 160 indicative of changes in body position of the user 200 are also indicative of changes in the body support 110 conditions, and thus the user support and relative comfort of the user 200. If the analysis determines the change is adversely affecting user support and/or relative comfort of the user 200, the analysis will provide commands to the body support 110 to adapt to the changing conditions.

At step 412, the processing system 120 generates and provides instructions (or commands) for the body support 110 to adjust one or more of the adjustable bladders 222 of the adjustable layer 220. The instructions are transmitted to the body support 110 along the first communication link 130. Once received by the body support 110, the body support 110 executes the instructions.

Referring back to FIGS. 3 and 4, the control unit 230 receives the instructions, ascertains the applicable one or more adjustable bladders 222 of the adjustable layer 220, and determines whether the one or more bladders 222 need to be inflated or deflated.

If the one or more bladders 222 require inflation, the applicable bladders 222 are isolated by actuating or opening the associated valve or valves 229. In embodiments where the bladders 222 are under a vacuum, opening the valve or valves 229 results in air inflating the bladders 222, as the bladders 222 are no longer under vacuum. Otherwise, in embodiments where the bladders 222 are not under a vacuum, the valve or valves 229 may be opened and the vacuum pump 231 is actuated to pump air into the bladders 222 through tubes 227a, b, c to inflate the associated internal bladders 225 until reaching a desired or targeted thickness. The desired thickness may range from thickness Tc, up to and including thickness Td. Once the applicable bladders 222 reach the desired thickness, the associated valve or valves 229 are closed.

If the one or more bladders 222 require deflation, the applicable bladders 222 are isolated by actuating or opening the associated valve or valves 229, and the vacuum pump 231 is actuated to pump air out of the bladders 222 through tubes 227a, b, c. This deflates the internal bladder 225 until reaching a desired or targeted thickness. The desired thickness may range from thickness Td, down to and including thickness Tc. Once the applicable bladders 222 reach the desired thickness, the associated valve or valves 229 are closed.

It should be appreciated that whether inflating or deflating the bladders 222, the desired thickness of the bladders 225 may be identified by closed loop control through the sensors 260 and/or body image scanner 140. When the desired or targeted thickness is reached, as measured by the information generated by the sensors 260 and/or body image scanner 140, the processing system 120 may send additional instructions (or commands) to the body support 110 to stop adjustment of the bladders 222.

Once the adjustable layer 220 has been adaptively changed to adjust for the change in conditions, the process returns to steps 408 and/or 410 and repeats as the conditions change. This cycle continues until the user wakes up and terminates operation of the process 400 at step 414.

In the embodiment illustrated in the figures and described herein, the body support 110 is adjustable by inflation and deflation of one or more bladders 225 provided in at least one layer 220 of the body support 110. However, it will be appreciated that a wide variety of other body support adjustment systems exist that can be used in conjunction with the body image scanner 140 and processing system 120 described herein. By way of example only, either or both layers 220, 240 of the body support 110 can be provided with a fluid conduit through which heated or cooled air or liquid is pumped in order to increase or decrease the firmness of the foam (e.g., viscoelastic foam) in desired areas of the body support 110. As another example, any portion of the body support can be raised or lowered in any manner (e.g., adjustable mattress foundation, inflatable bolsters and/or inflatable lateral rotation assemblies, and the like). Still other devices and systems for increasing or decreasing the firmness of particular areas of the body support 110 and/or for changing the shape of particular areas of the body support 110 can be employed as desired, and are suitable for use with the body image scanner 140 and processing system 110 described herein—whether in conjunction with the bladder system described above or otherwise.

The adaptable body support system 100 provides for adjustment (and in some embodiments, real-time adjustment) of a body support 110 based on changing conditions associated with the user 200 and the body support 110. This adaptability improves user support and the relative comfort of the user 200, which in turn improves the experience and sleep quality for the user 200. These and other advantages may be realized from one or more embodiments of the system, processes, and associated body support disclosed herein.

What is claimed is:

1. A system for adjusting a body support during use, the system comprising:
a body support having an adjustable layer and a plurality of sensors;
a camera;
a processing system in communication with the camera, the plurality of sensors, and the adjustable layer, wherein the processing system receives information from either or both the camera and the plurality of sensors, and then transmits instructions to the adjustable layer to adjust the layer.

2. The system of claim 1, wherein the adjustable layer includes a plurality of adjustable bladders.

3. The system of claim 2, wherein the instructions to the adjustable layer include inflating or deflating at least one of the adjustable bladders.

4. The system of claim 2, wherein each of the plurality of adjustable bladders includes an internal bladder, each of the internal bladders is fluidly connected to a pump by a tube, and wherein the pump injects a fluid into or removes a fluid from each of the internal bladders.

5. The system of claim 4, wherein each of the internal bladders is fluidly connected to a common pump.

6. The system of claim 4, wherein the fluid is air.

7. The system of claim 4, wherein the adjustable layer includes a layer of foam surrounding at least a portion of the internal bladders.

8. The system of claim 1, wherein the body support includes a second layer adjacent the first layer.

9. The system of claim 8, wherein the second layer is formed of foam.

10. The system of claim 1, wherein the plurality of sensors is a sensor array positioned adjacent the adjustable layer.

11. The system of claim 10, wherein the sensor array is positioned on a user side of the adjustable layer.

12. The system of claim 1, wherein the camera is part of a body image scanner in communication with the processing system.

13. The system of claim 12, wherein the body image scanner includes at least one time-of-flight camera.

14. The system of claim 13, wherein the at least one time-of-flight camera emits light wavelengths outside the visual light spectrum.

15. The system of claim 12, wherein the processing system receives image information from the body image scanner and then transmits instructions to the adjustable layer to adjust the layer.

16. The system of claim 15, wherein the image information is a depth image of a user on the body support.

17. A system for adjusting a body support during use, the system comprising:
a body support having an adjustable layer;
a body image scanner in operational communication with the body support; and
a processing system in communication with the adjustable layer by a first communication link, and in communication with the body image scanner by a second communication link, wherein the processing system receives depth image information from the body image scanner and then transmits instructions to the adjustable layer to adjust the layer.

18. The system of claim 17, wherein the adjustable layer includes a plurality of adjustable bladders.

19. The system of claim 18, wherein the instructions to the adjustable layer include inflating or deflating at least one of the adjustable bladders.

20. The system of claim 18, wherein each of the plurality of adjustable bladders includes an internal bladder, wherein each of the internal bladders is fluidly connected to a pump by a tube, and wherein the pump injects a fluid into or removes a fluid from each of the internal bladders.

21. The system of claim 20, wherein each of the internal bladders is fluidly connected to a common pump.

22. The system of claim 20, wherein the fluid is air.

23. The system of claim 20, wherein the adjustable layer includes a layer of foam surrounding at least a portion of the internal bladders.

24. The system of claim 17, wherein the body image scanner is at least one time-of-flight camera.

25. The system of claim 24, wherein the at least one time-of-flight camera emits light wavelengths outside the visual light spectrum.
